(19) United States
(12) Patent Application Publication
(10) Pub. No.: US 2011/0283189 A1
(43) Pub. Date: Nov. 17, 2011

(54) SYSTEMS AND METHODS FOR ADJUSTING MEDIA GUIDE INTERACTION MODES

(75) Inventor: Michael McCarty, Agoura Hills, CA (US)

(73) Assignee: Rovi Technologies Corporation, Santa Clara, CA (US)

(21) Appl. No.: 12/778,364

(22) Filed: May 12, 2010

(51) Int. Cl. G06F 3/01; G06F 3/048

(52) U.S. Cl. 715/707; 715/810

(57) ABSTRACT

Described herein are systems and methods for recognizing when a user of an interactive application is frustrated and for responding to the user's frustration by changing an interaction mode. In response to detecting a frustration pattern in a user signal, an interaction mode of the application may be adjusted. Adjusting an interaction mode may include adjusting the presentation of any one or more interactive application elements (for example, available options, valid user commands, display characteristics and items presented to the user).

### BACKGROUND OF THE INVENTION

Interactive applications, such as interactive media guides, often provide users with many features and options. As the number and complexity of available features grows, some users may find these applications more challenging to learn and navigate. Some systems offer a “help” feature which requires a user to request help by activating a dedicated input (e.g., pressing a “help” button). Some of these systems then overlay the application with help menus or redirect the user to a tutorial. However, some users resist using help features, and may only do so when excessively frustrated. Further, such systems may impede a user's practice with the interactive application by obscuring and complicating the display with pop-up windows, or exiting the application to enter a separate tutorial.

### SUMMARY OF THE INVENTION

Consequently, there is a need for systems and methods for recognizing when a user of an interactive application is frustrated and for responding to a user's frustration by adjusting an interaction mode. An interaction mode may specify the presentation of a set of interactive application elements (e.g., the content and format of a display). The systems and methods described herein may improve a user's experience by monitoring user signals (e.g., signals from a user input interface or signals from other user sensors, such as a microphone) for patterns indicating a user's frustration. When a frustration pattern is detected, these systems and methods may respond by adjusting an interaction mode of the application from a current interaction mode (which may be contributing to the user's frustration) to a different “target” interaction mode (which may reduce the user's frustration). Adjusting an interaction mode may include adjusting the presentation of any one or more interactive application elements (for example, available options, valid user commands, display characteristics and items presented to the user). Further, the systems and methods of the present disclosure may provide multiple different interaction modes, each of which may be used as the target mode in response to a different detected frustration pattern, or pre-selected by a user. Also described herein are systems and methods for aggregating frustration information and interaction mode information and using this information to improve interaction mode adjustment in response to user frustration.

### BRIEF DESCRIPTION OF THE DRAWINGS

The above and other objects and advantages of the systems and methods of the present disclosure will be apparent upon consideration of the following detailed description, taken in conjunction with the accompanying drawings, in which like reference characters refer to like parts throughout, and in which:

FIGS. 1 and 2 depict illustrative displays that may be used to provide interactive application items;

FIG. 3A depicts an illustrative user equipment device;

FIG. 3B is a simplified diagram of an illustrative interactive media system which may be used with various embodiments;

FIG. 4 is a flow diagram of a frustration detection/mode adjustment process in accordance with an embodiment;

FIGS. 5A-5G depict illustrative interaction mode adjustments to the display of FIG. 1;

FIGS. 6A-6D depict illustrative interaction mode adjustments to the display of FIG. 2;

FIG. 7 is a flow diagram of a frustration pattern detection process in accordance with an embodiment; and

FIG. 8 is a flow diagram of an interaction mode adjustment process in accordance with an embodiment.

### DETAILED DESCRIPTION OF EMBODIMENTS

The frustration detection/interaction mode adjustment systems and methods disclosed herein may be readily applied with any interactive application (e.g., interactive software, interactive websites, interactive television programs, and interactive presentations). For illustrative purposes, this disclosure will often discuss exemplary embodiments of these systems and methods as applied with media delivery applications, but it will be understood that these illustrative examples do not limit the range of interactive applications which may be improved by the use of the systems and methods disclosed herein.

In the context of a media delivery system, the amount of media available to users can be substantial. Additional media interaction features (e.g., downloading, editing, sharing) further increase the possibilities available to a user of a media delivery system. Consequently, many users desire a form of media guidance through an interface that allows users to efficiently navigate media selections to easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, webcasts, etc.), and other types of media or video content. Guidance applications allow users to navigate among and locate content related (and unrelated) to the video content including, for example, video clips, articles, advertisements, chat sessions, games, etc. Guidance applications allow users to navigate among and locate multimedia content, as well as edit, store, and share such content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, and can be part of a live performance. It should be understood that the embodiments that are discussed in relation to media content are applicable to any type of content, such as video, audio, text, still images, and/or multimedia.

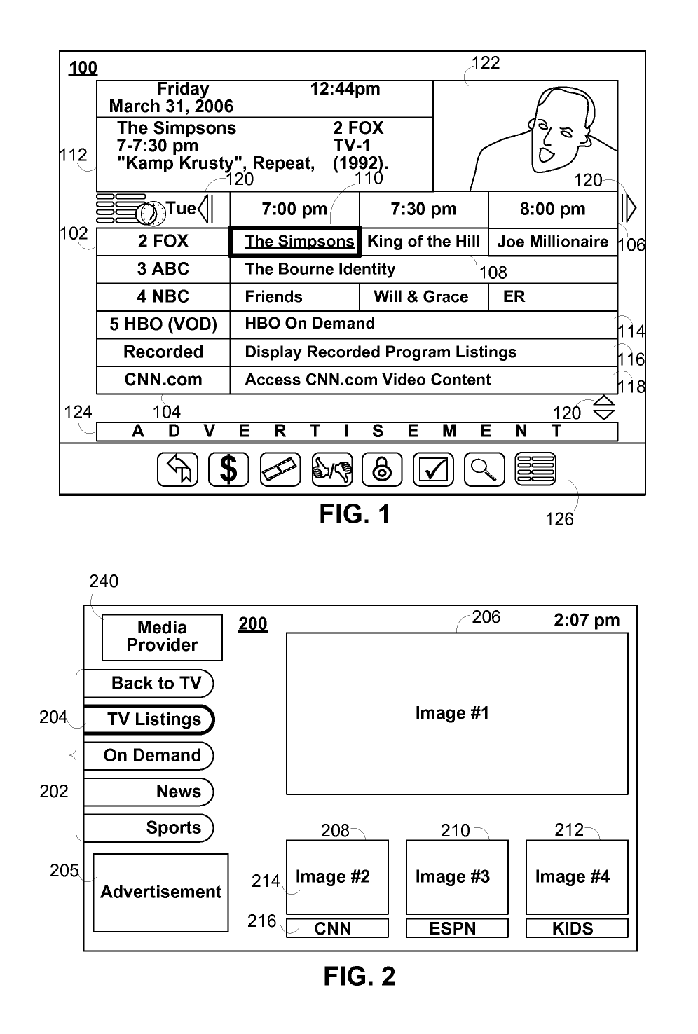

One of the functions of a media guidance application is to provide media listings and media information to users. FIGS. 1-2, 5A-5G and 6A-6D show illustrative displays that may be used to provide media guidance, and in particular media listings. The displays shown in FIGS. 1-2, 5A-5G and 6A-6D may be implemented on any suitable device or platform. While the displays of FIGS. 1-2, 5A-5G and 6A-6D are illustrated as full screen displays, they may also be fully or partially overlaid over media content or other interactive application information being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organizational criteria.

FIG. 1 shows illustrative grid program listings display 100 arranged by time and channel, which enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

Display 100 may include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present disclosure.

Options region 126 may allow the user to access different types of media content, media guidance application displays, and/or media guidance application features. Options region 126 may be part of display 100 (and other display screens of the present disclosure), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting a program and/or a channel as a favorite, purchasing a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

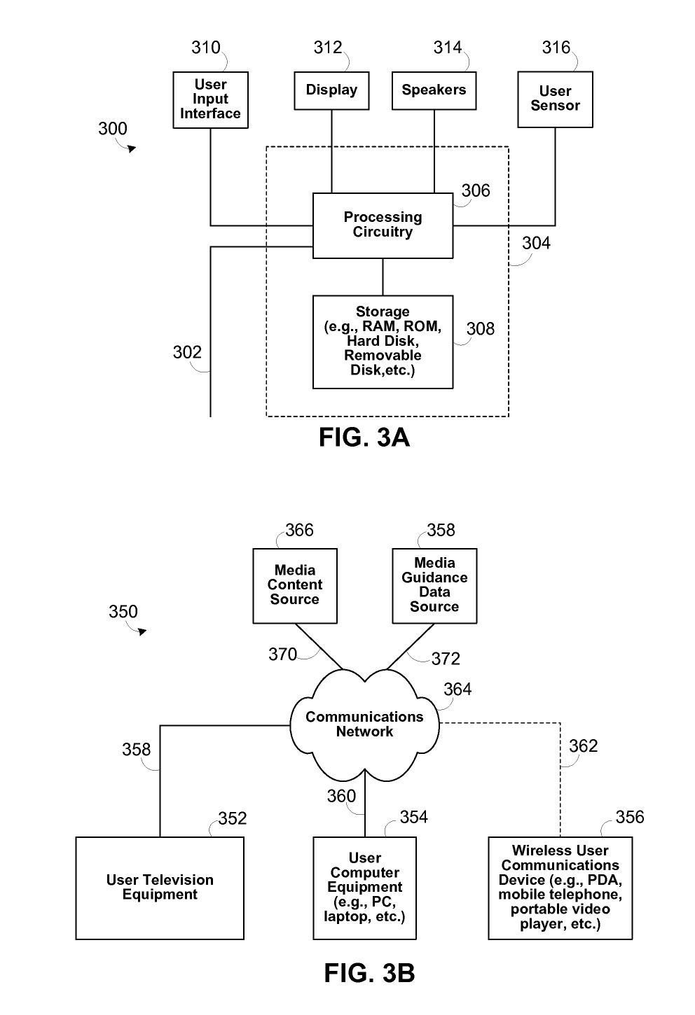

The media guidance application may allow a user to provide user profile information or may automatically compile user profile information. The media guidance application may, for example, monitor the media the user accesses and/or other interactions the user may have with the guidance application (including user signals that may indicate user frustration, as described in detail herein). Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 3B. Additional personalized media guidance application features are described in greater detail in Ellis et al., U.S. patent application Ser. No. 11/179,410, filed Jul. 11, 2005, Boyer et al. U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties. Customization of interactive applications is discussed in detail herein, particularly in the context of frustration detection and interaction mode adjustment.

Another display arrangement for providing media guidance is shown in FIG. 2. Video mosaic display 200 includes media provider identifier 240, advertisement 205, and selectable options 202 for media content information organized based on media type, genre, and/or other organization criteria. In display 200, television listings option 204 is selected, thus providing listings 206, 208, 210 and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicate to a user the media content being described by the listing. Each of the graphical listings may be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel on which the video is displayed). Further discussion of various configurations for display screens 100 (FIG. 1) and 200 (FIG. 2), as well as many other exemplary displays, are presented elsewhere herein.

Users may access media content and media guidance applications (and the display screens described above and below) from one or more of their user equipment devices. FIG. 3A shows a generalized embodiment of illustrative user equipment device 300. More specific implementations of user equipment devices are discussed below in connection with FIG. 3B. User equipment device 300 may receive media content and data via input/output (hereinafter “I/O”) path 302. I/O path 302 may provide media content (e.g., broadcast programming, on-demand programming, Internet content, peer-to-peer content and other video, audio and text) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3A to avoid overcomplicating the drawing.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or may be integrated with other elements of user equipment device 300. Display 312 may be one or more of a monitor, a television, a liquid crystal display (LCD) for a mobile device, or any other suitable equipment for displaying visual images and text. In an embodiment, display 312 may be HDTV-capable. Speakers 314 may be integrated with other elements of user equipment device 300 or may be stand-alone units. The audio component of videos and other media content displayed on display 312 may be played through speakers 314. In an embodiment, the audio may be distributed to a receiver (not shown), which processes and outputs the audio via speakers 314.

A user sensor 316 included with the user equipment device 300 may transmit user signals to the control circuitry 304. The user sensor 316 may include any one or more sensing devices, such as a microphone, an accelerometer, a force gauge, an anemometer, a temperature sensor, a level sensor, and any other sensor capable of measuring chemical, electrical, mechanical, spatial, biological or other characteristics of a user. Processing circuitry 306 may be configured to receive and interpret signals produced by any sensor included in user sensor 316, as described in detail below. Additional discussion of suitable configurations of user equipment device 300 is presented elsewhere herein.

User equipment device 300 of FIG. 3A can be implemented in system 350 of FIG. 3B as user television equipment 352, user computer equipment 354, wireless user communications device 356, or any other type of user equipment suitable for supporting an interactive application and/or accessing media, such as a non-portable gaming machine. For simplicity, these devices may be referred to herein collectively as user equipment or user equipment devices. User equipment devices, with which an interactive application is implemented, may function as a standalone device or may be part of a network of devices. Various network configurations of devices may be implemented and are discussed in detail below.

User equipment devices may be coupled to communications network 364. Namely, user television equipment 352, user computer equipment 354, and wireless user communications device 356 may be coupled to communications network 364 via communications paths 358, 360, and 362, respectively. Communications network 364 may be one or more networks including the Internet, a mobile phone network, mobile device (e.g., Blackberry) network, cable network, public switched telephone network, or other types of communications networks or combinations of communications networks. BLACKBERRY is a service mark owned by Research In Motion Limited Corp. Paths 358, 360, and 362 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 362 is drawn with dotted lines to indicate that, in the exemplary embodiment shown in FIG. 3B, path 362 is a wireless path, and paths 358 and 360 are drawn as solid lines to indicate they are wired paths (although these paths may be wireless paths, if desired). Communications with the user equipment devices may be provided by one or more of these communications paths, but are shown as a single path in FIG. 3B to avoid overcomplicating the drawing.

System 350 includes media content source 366 and media guidance data source 368 coupled to communications network 364 via communication paths 370 and 372, respectively. Paths 370 and 372 may include any of the communication paths described above in connection with paths 358, 360, and 362. Communications with media content source 366 and media guidance data source 368 may be exchanged over one or more communications paths, but are shown as a single path in FIG. 3B to avoid overcomplicating the drawing. In addition, there may be more than one of each of media content source 366 and media guidance data source 368, but only one of each is shown in FIG. 3B to avoid overcomplicating the drawing. Different possible types of each of these sources are discussed below. If desired, media content source 366 and media guidance data source 368 may be integrated as one source device. Although communications between sources 366 and 368 with user equipment devices 352, 354, and 356 are shown as through communications network 364, in an embodiment, sources 366 and 368 may communicate directly with user equipment devices 352, 354, and 356 via communication paths (not shown) such as those described above in connection with paths 358, 360, and 362. Additional discussion of suitable configurations of system 350 is presented elsewhere herein.

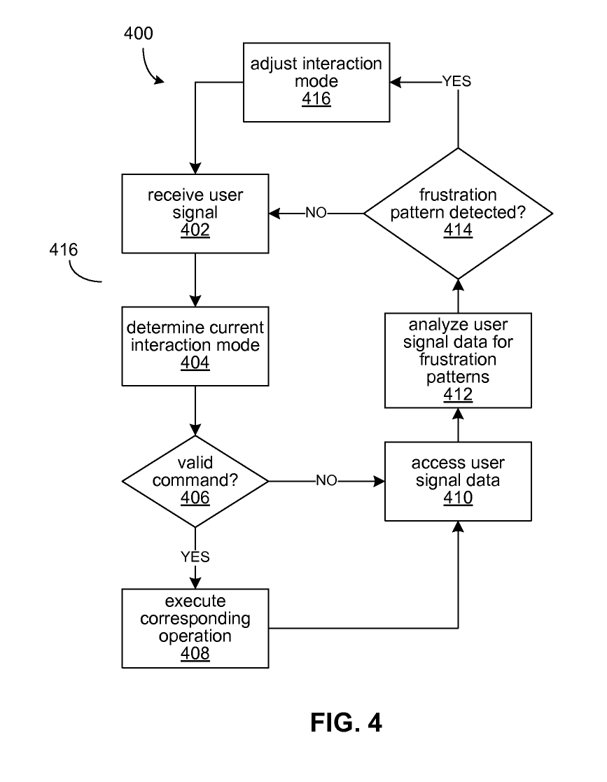

Any of the embodiments of user equipment 300 and system 350 of FIGS. 3A and 3B may be used with the frustration detection/mode adjustment systems and methods disclosed herein (sometimes abbreviated as frustration detection/mode adjustment systems and methods), now discussed in further detail. FIG. 4 is a flow chart 400 of an illustrative frustration detection/mode adjustment process in accordance with the present disclosure. Although the steps of flow chart 400 will be described as executed by processing circuitry 306 (FIG. 3A) for clarity of illustration, it will be understood that any frustration detection/mode adjustment process may be performed by any device or group of devices configured to do so; for example, special- or general-purpose processing circuitry located within user equipment device 300 (FIG. 3A) or any appropriately-configured component of interactive system 350 (FIG. 3B).

At step 402 (FIG. 4), processing circuitry 306 (FIG. 3A) may receive a user signal. The user signal may come from user sensor 316, user input interface 310, or both. In an embodiment, the user sensor 316 may include one or more sensors, such as a microphone, an accelerometer, a force gauge, an anemometer, a temperature sensor, a level sensor, and any other sensor capable of measuring chemical, electrical, mechanical, spatial, biological or other characteristics of a user. In an embodiment, the user input signal may come from user input interface 310, as any combination of one or more button presses on a handheld device, a set-top box, a keyboard, a mouse, a trackball, a scroll wheel, a touch pad, or a series of verbal instructions. The user signal received at step 402 (FIG. 4) may have been previously stored in a memory (e.g., a buffer or RAM included with storage 308 of FIG. 3A).

At step 404 (FIG. 4), processing circuitry 306 (FIG. 3A) may determine the current interaction mode of an interactive application. To determine the current interaction mode, processing circuitry 306 may query one or more internal variables or may query other devices in communication with processing circuitry 306 (e.g., other elements of user equipment 300 or components of interactive system 350 via communications network 364 of FIG. 3B). In an embodiment, processing circuitry 306 maintains a record of the current interaction mode as a state variable in a memory (e.g., storage 308 or an external or remote memory). For example, if processing circuitry is capable of implementing eight different interaction modes, three or more bits of memory may be used to store a variable indicating which of the eight different modes is the current mode.

At step 406 (FIG. 4), processing circuitry 306 (FIG. 3A) may determine whether the user signal received at step 402 includes a valid command. A valid command may be a portion of a signal recognized by processing circuitry 306 as corresponding to a valid interactive application operation, and may depend upon the currently available interactive application options and/or the current interaction mode (as determined at step 404 of FIG. 4). For example, when a user is presented with a display, such as display 100 of FIG. 1, valid commands may include, for example, navigation commands (e.g., pressing right, left, up and down arrows on a keypad or touchscreen), and selection commands (e.g., pressing an “enter” button on a remote control or pressing highlight region 110 of FIG. 1 on a touch-sensitive screen to select the program listing for “The Simpsons”). Invalid commands may include commands not recognized by the interactive application as corresponding to one or more of the options available to the user and/or any valid interactive application operation. If none of the user signals received at step 402 (FIG. 4) originated from a valid source of commands (e.g., user input interface 310 of FIG. 3A), processing circuitry 306 (FIG. 3A) may determine that the user signal cannot include a valid command. If the processing circuitry 306 determines at step 406 that the user signal received at step 402 includes a valid command signal, processing circuitry 306 may execute the operation corresponding to the command at step 408.

After the operation is executed at step 408 (FIG. 4), or if processing circuitry 306 (FIG. 3A) determines at step 406 (FIG. 4) that the user signal received at step 402 (FIG. 4) does not include a valid command, processing circuitry 306 may begin a frustration detection process at step 410 (FIG. 4) by accessing data regarding one or more user signals. The user signals accessed may include signals from user sensors 316 (FIG. 3A), signals from user input interface 310, or any combination thereof. The user signals accessed at step 410 (FIG. 4) may have been previously stored in a memory (e.g., a buffer or RAM included with storage 308 of FIG. 3A).

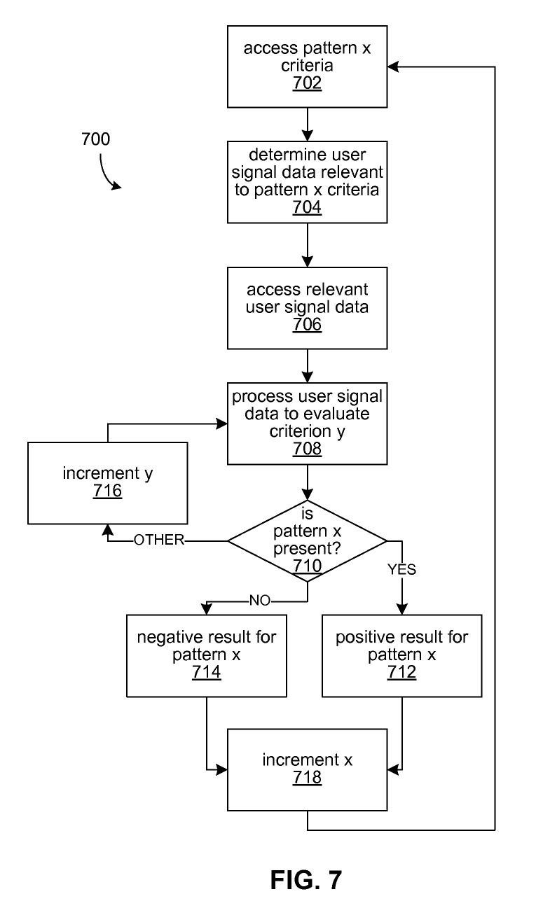

At step 412 (FIG. 4), processing circuitry 306 (FIG. 3A) may analyze the user signal data accessed at step 410 for one or more frustration patterns. A frustration pattern may be a signal characteristic, or a combination of multiple characteristics present in one or more user signals, which may indicate user frustration. The analysis of step 412 (FIG. 4) may include searching for multiple different frustration patterns in the user signal data; these different frustration patterns may indicate different types of user frustration. Frustration pattern detection processes are discussed in additional detail below (e.g., with reference to FIG. 7).

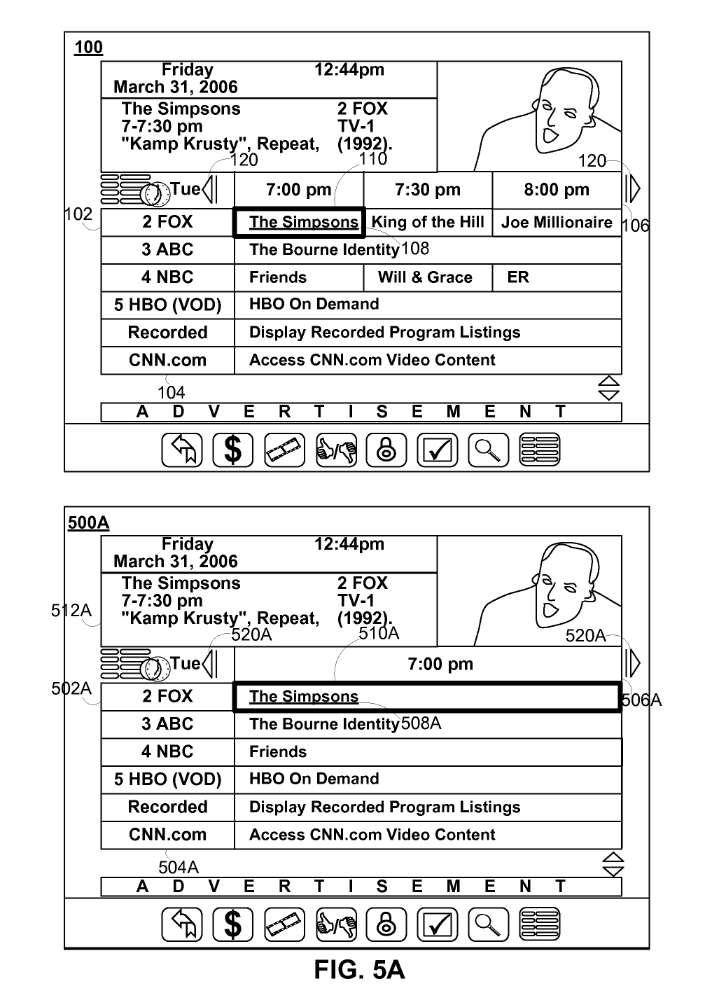

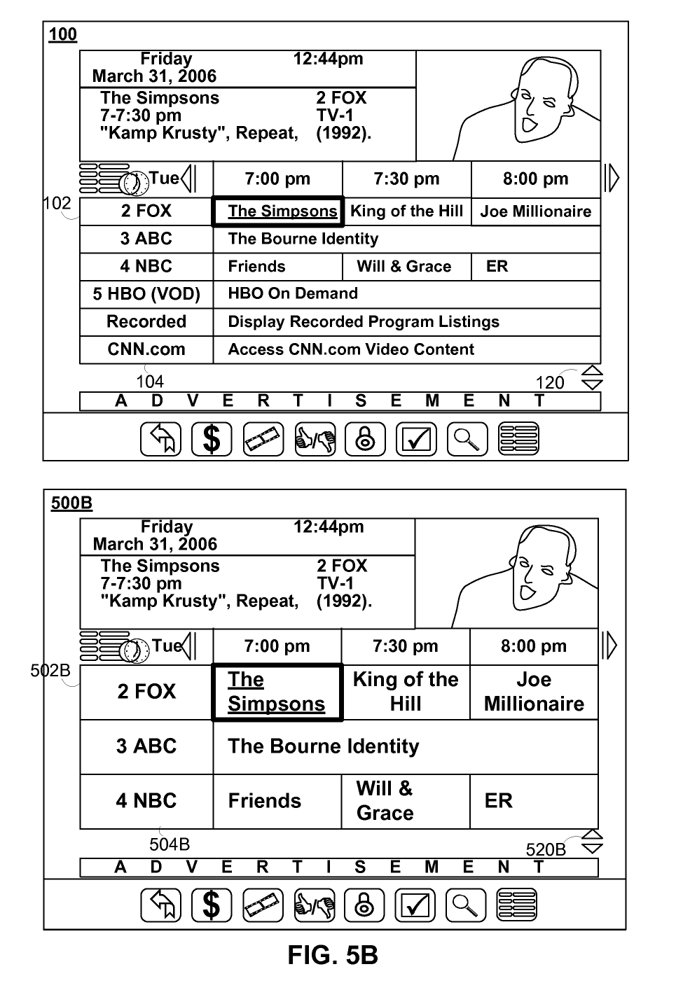

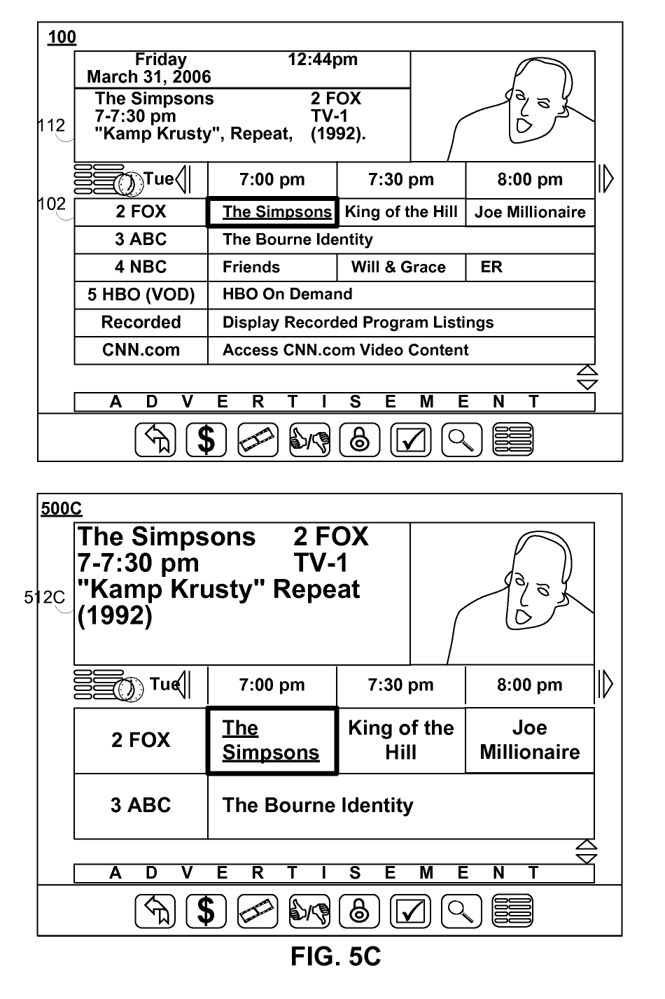

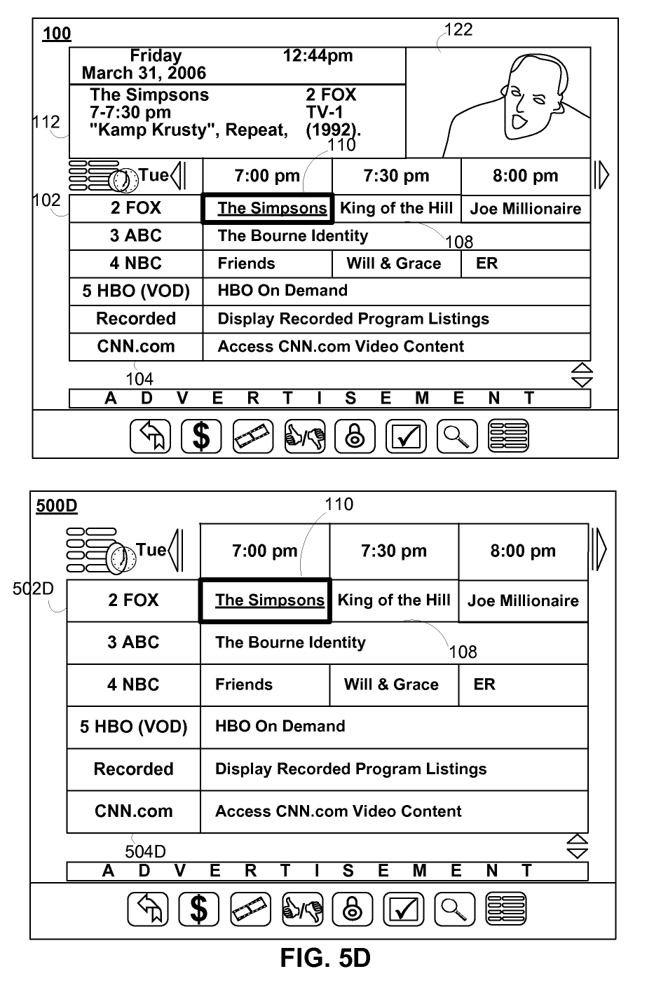

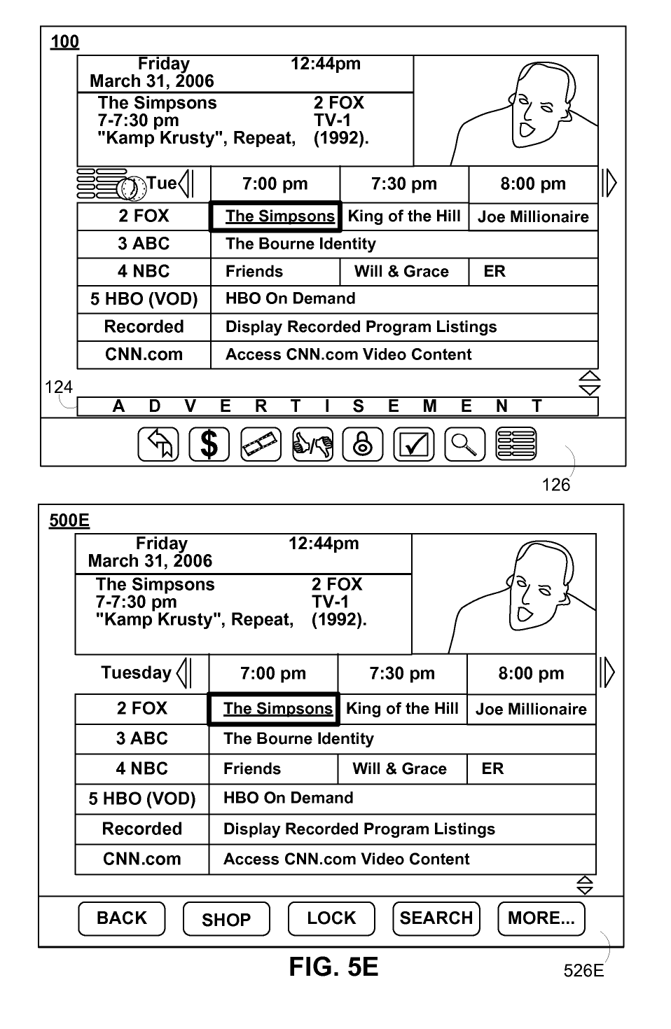

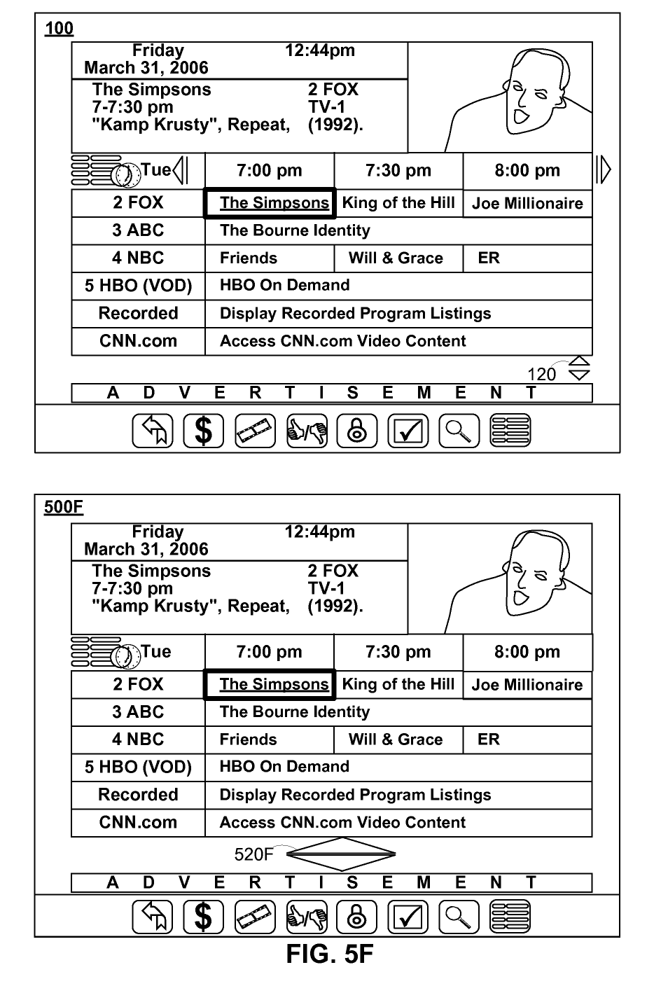

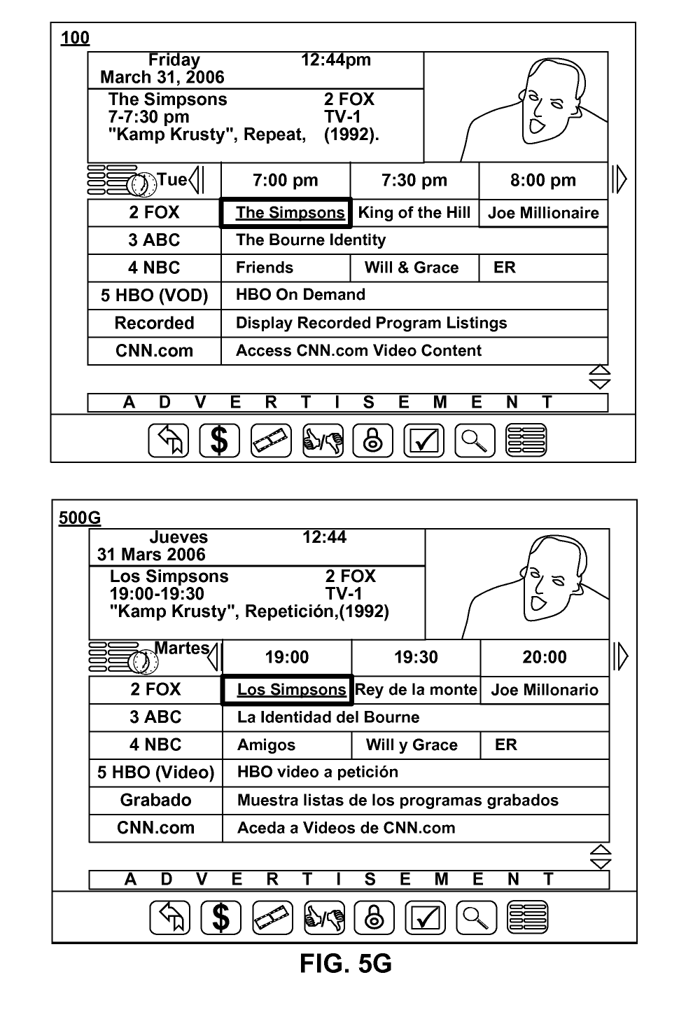

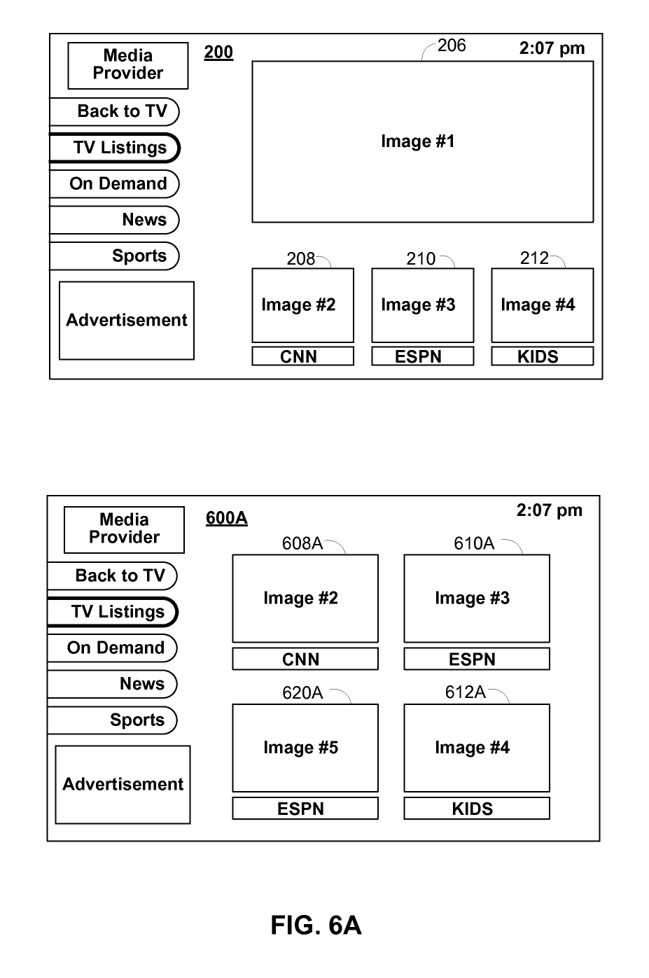

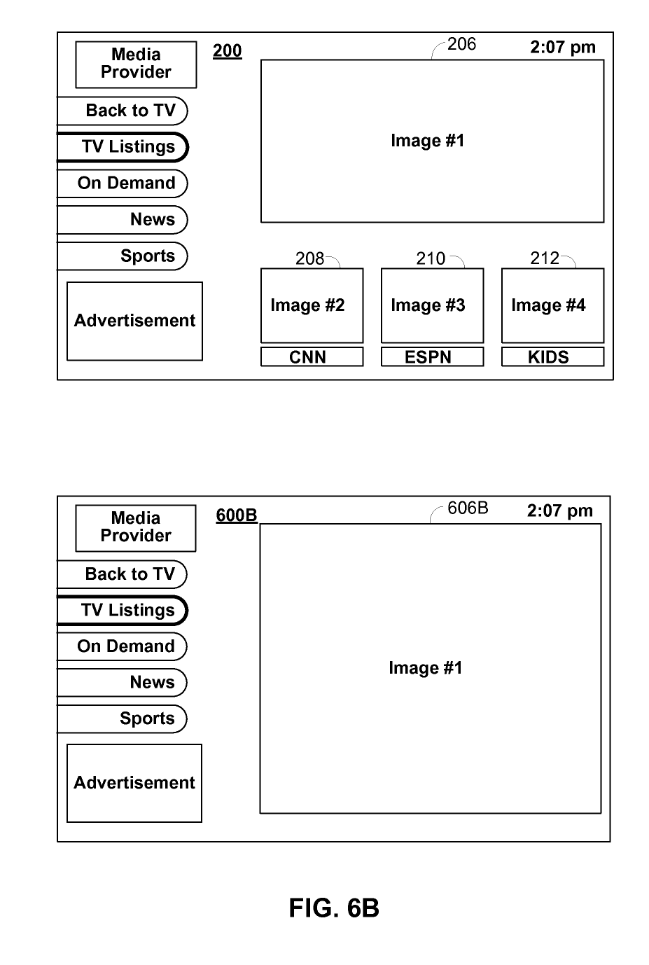

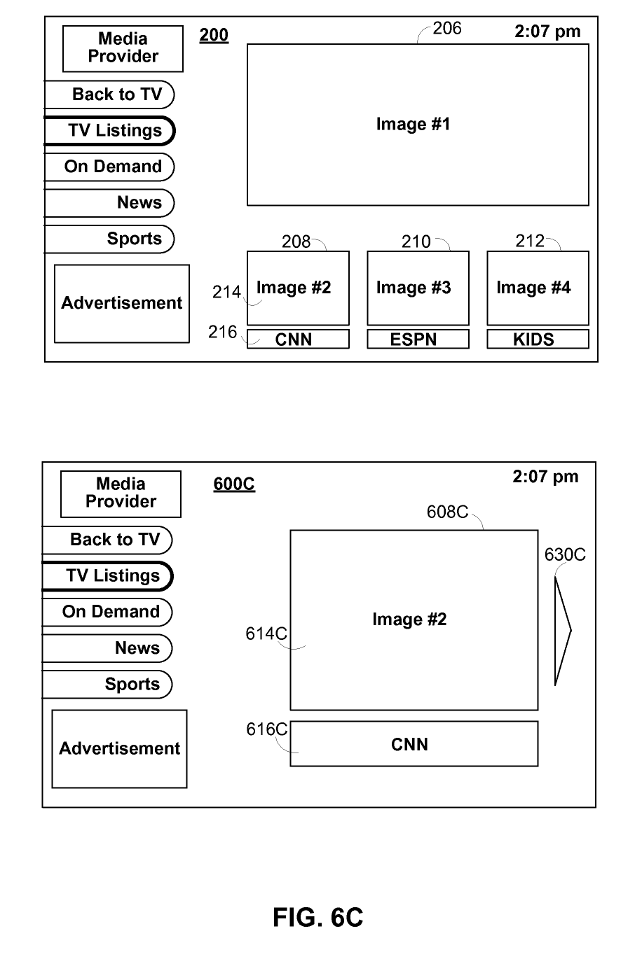

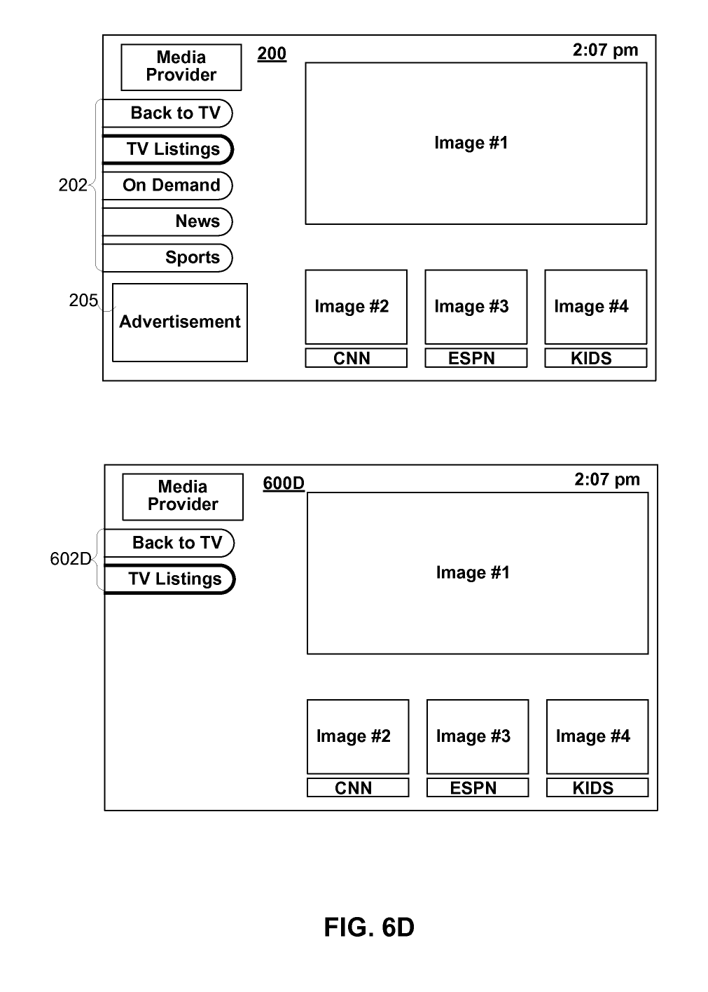

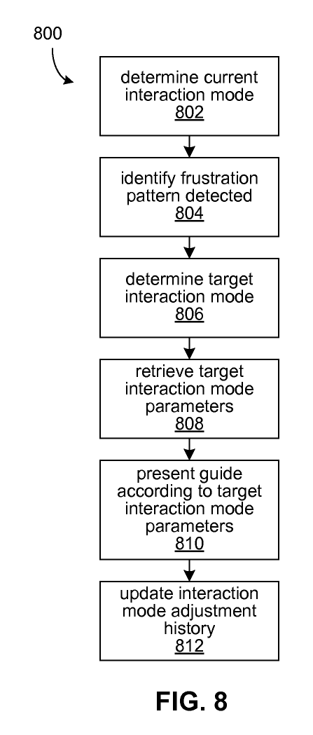

If processing circuitry 306 (FIG. 3A) detects one or more frustration patterns at step 414 (FIG. 4) as a result of the analysis performed at step 412 (FIG. 4), processing circuitry 306 may adjust the interaction mode at step 416 (FIG. 4). Examples of interaction mode adjustments are depicted in FIGS. 5A-5G and 6A-6D and are discussed below. Illustrative frustration detection and mode adjustment processes are discussed below with reference to FIGS. 7 and 8, respectively. It will be noted that any of the mode adjustment processes described herein may be accompanied by conventional interaction application assistance techniques, such as help buttons, tutorials, pop-up suggestions, and any other conventional technique.

FIGS. 5A-5G depict illustrative interaction mode adjustments to display 100 of FIG. 1 in accordance with the present disclosure. In each of FIGS. 5A-5G, display 100 of FIG. 1 is reproduced (top). The displays 500A-500G (bottom) of FIGS. 5A-5G, respectively, are intended to illustrate a small number of the types of interaction mode adjustments that may be made by the systems and methods of the present disclosure, and it will be understood that any items or characteristic of any of these displays, such as formatting, content, options, size, descriptive text and icons may be modified, exchanged or combined to achieve any of the interaction mode adjustment and frustration reduction goals described herein, or any other goal. Further, different display and content features of any of the interaction mode embodiments described herein may be recombined and rearranged in any desired manner.

Display 500A of FIG. 5A represents an interaction mode in which fewer time identifiers are included in row 506A than are included in row 106 of display 100 (which may represent a nominal or default interaction mode). Left and right navigational icons 520A may shift the time block of programming for which listings are displayed in grid 502A (as left and right navigational icons 120 do for the listings in grid 102). In an embodiment, more information about each listing in grid 502A may be presented than is presented in the corresponding cell of grid 102. In an embodiment, the information about each listing in grid 502A may be the same information provided about the corresponding listing in grid 102, but the information in grid 502A may be displayed with larger text, emphasized text, or with more text-free space between listings.

Display 500B of FIG. 5B represents an interaction mode in which fewer channel/media type identifiers are included in column 504B than are included in column 104 of display 100. Up and down navigational icons 520B may change the channels/media types for which listings are displayed in grid 502B (as up and down navigational icons 120 do for the listings in grid 102 of display 100). In an embodiment, more information about each listing in grid 502B may be presented than is presented in the corresponding cell of grid 102. In an embodiment, the information about each listing in grid 502B may be the same information provided about the corresponding listing in grid 102, but the information in grid 502B may be displayed with larger text, emphasized text, or with more text-free space between listings. Interaction modes like the modes represented by displays 500A and 500B may reduce a user's frustration by simplifying the display and/or making the presented items more visually distinct.

Display 500C of FIG. 5C represents an interaction made in which fewer channel/media type identifiers are included in column 504C than are included in column 104 of display 100. Additionally, the text height in program information region 512C and grid 502C is larger than the text height in program information region 112 and grid 102, respectively. An interaction mode in which text height, width, color, boldness, font or other characteristic is adjusted to increase visibility (for example, the mode represented by display 500C) may reduce a user's frustration by improving the legibility of the displayed text.

Display 500D of FIG. 5D represents an interaction made in which program listings grid 502D is enlarged to fill the portion of the screen covered by grid 102, program information region 112 and video region 122 in display 100. Interaction mode adjustments represented by display 500D include increasing the size of programs listings grid 502D (as compared to program listings grid 102 of display 100), and not displaying the non-programs listings grid items of display 100 (i.e., program information region 112 and video region 122). Adjusting the interaction mode by removing a video region (or any other region) from a display may reduce the number of displayed items competing for a user's attention, and thus reduce a user's frustration. In an embodiment, any audio information accompanying video region 122 (or any other region of display 100) may or may not be provided with the display 500D, may be provided at a lower volume, or may be replaced by audio information intended to reduce a user's frustration (e.g., soothing music or sounds, spoken help instructions, or portions of a user's favorite music or audio broadcasts).

Display 500E of FIG. 5E represents an interaction mode in which options region 526E includes text-based selectable options instead of the icon-based selectable options included in options region 126 of display 100. Text-based displays may be more easily interpreted then icon-based displays by certain users (e.g., when interactive applications are shared across cultural groups with different ways of interpreting icons). Display 500E also includes the full name of the day of the week represented by the listings in grid 502E (i.e., “Tuesday”), rather than the abbreviation “Tue” displayed with grid 102 of display 100. Certain users may find abbreviations difficult to understand, and thus may experience reduced frustration when abbreviated terms are expanded.

Display 500F of FIG. 5F represents an interaction mode in which “up/down” navigation icons 520F have been relocated and enlarged from the position and size of “up/down” navigation icons 120 included with display 100. Navigation icons 520F of display 500F may be more apparent to a user than navigation icons 120 of display 100, which may reduce the frustration of a user unable to determine how to navigate up and down within program listings grid 102 of display 100. Any suitable technique for highlighting an item in a display may be used, including using color, motion, sound, size or any other characteristic of the item.

Display 500G of FIG. 5G represents an interaction mode in which the text of the display 500G is in a language different than the language of display 100. In particular, the text of display 500G is presented in Spanish, while the text of display 100 is presented in English. Such an interaction mode adjustment may be made, for example, when a microphone included in user sensor 316 determines that a user is speaking in Spanish, and may or may not be experiencing frustration. Presenting the text of the display 500G in Spanish (without requiring a user to navigate a series of settings menus to set a language preference, if such an option even exists) may reduce a user's frustration.

FIGS. 6A-6D depict illustrative interaction mode adjustments to the display 200 of FIG. 2 in accordance with the present disclosure. As discussed above with reference to FIGS. 5A-5G, the display screens of FIGS. 6A-6D are intended to illustrate a small number of the types of interaction mode adjustments that may be made by the systems and methods of the present disclosure, and it will be understood that any items or characteristics of any of these displays, such as formatting, content, options, size, descriptive text and icons may be modified, exchanged or combined to achieve any of the interaction mode adjustment and frustration reduction goals described herein.

Display 600A of FIG. 6A represents an interaction mode in which listings 608A, 610A, 612A and 620A largely fill the region of the display occupied by listings 206, 208, 210, and 212 in display 200. In an interaction mode as represented by display 600A, the size of each listing is distributed more evenly across listings than in display 200, which may make it easier for a user to view and compare different listings and thus reduce user frustration.

Display 600B of FIG. 6B represents an interaction mode in which listing 606B largely fills the region of the display occupied by listings 206, 208, 210, and 212 in display 200. In an interaction mode represented by display 600B, fewer listings may be presented than in the interaction mode represented by display 200 (e.g., only a single listing in display 600B). Displaying fewer listings may allow a user to focus on a single listing at a time, and thus reduce frustration caused by too many items competing for a user's attention.

Display 600C of FIG. 6C represents an interaction mode in which listing 606C largely fills the region of the display occupied by listings 206, 208, 210, 212 in display 200, and a navigation option 630C is displayed. Display 600C may have the frustration-reducing advantages of display 600B of FIG. 6B. Further, navigation option 630C may provide a visually distinct option for the display of additional listings (e.g., selecting navigation option 630C may replace listing 606C with another listing) without displaying multiple listings simultaneously (as in display 200).

Display 600D of FIG. 6D represents an interaction mode in which fewer selectable options 602D are presented than the number of selectable options 202 in display 200. Additionally, advertisement 205 is not included in display 600D. As discussed above, reducing the number of items presented to a user by changing the interaction mode may reduce a user's frustration when faced with too many options and features. The selectable options included in options 602D may be chosen based on any of a number of factors, including the options a user has selected in the past, the options that a population of users has selected in the past (e.g., the most popular options), the options most likely to be chosen by a user given the other items currently displayed, the time of day, or any other factors. Indeed, in any of the embodiments described herein which include an interaction mode with a reduced number of options or features presented to a user, the presented options or features may be based on any factors described herein, including frustration patterns, historical usage, population usage, the results of predictive mathematical models, user feedback, or any other factor.

Certain embodiments of frustration detection and interaction mode adjustment processes are now discussed. FIG. 7 is a flow chart 700 of an illustrative frustration detection process in accordance with the present disclosure. Although the steps of flow chart 700 will be described as executed by processing circuitry 306 (FIG. 3A) for clarity of illustration, it will be understood that any frustration detection process may be performed by any device or group of devices configured to do so; for example, special- or general-purpose processing circuitry located within user equipment device 300 or any appropriately-configured component of interactive system 350 (FIG. 3B). In an embodiment, the steps of flow chart 700 (FIG. 7) may be executed by processing circuitry also configured to execute the steps of flow chart 400 (FIG. 4) or any other process described herein. In an embodiment, the steps of flow chart 700 (FIG. 7) may be performed in conjunction with the steps of flow chart 400 (FIG. 4); for example, at step 412 of flow chart 400 when processing circuitry 306 (FIG. 3A) analyzes user signal data for frustration patterns.

At step 702 of flow chart 700 (FIG. 7), processing circuitry 306 (FIG. 3A) may access criteria for a frustration pattern, designated frustration pattern x. Frustration pattern x may be the only frustration pattern that processing circuitry 306 is configured to detect, or frustration pattern x may be one of a plurality of frustration patterns detectable by processing circuitry 306. In an embodiment, frustration pattern criteria may be stored in a memory coupled to the processing circuitry 306 (e.g., by wired or wireless communication). The memory may be located in user equipment 300 (i.e., storage 308) or in any component of interactive media system 350 (FIG. 3B). For example, frustration pattern criteria may be stored in a remote database associated with media guidance data source 368. The criteria accessed by processing circuitry 306 (FIG. 3A) at step 702 (FIG. 7) may provide rules or guidelines for detecting a frustration pattern in user signal data. These rules or guidelines may take the form of any one or more of a hypothesis test, a maximum likelihood test, a decision tree, a logical expression, and any other decision technique. The following examples of frustration pattern criteria are intended to illustrate a small number of the types of frustration pattern criteria that may be used with the systems and methods of the present disclosure, and it will be understood that the ranges, comparisons, input signals and any other characteristic of these criteria may be adjusted or exchanged to achieve any of the frustration pattern detection goals described herein (or any other goal). Frustration pattern criteria may also include combinations of any one or more of the criteria described herein (i.e., combined via logical operations such as AND and OR, correlations, anti-correlations, two or more patterns occurring in sequence, in parallel, or separated by a time delay, etc.) or the lack of any of the criteria described herein (e.g., a period during which no user signals are received).
1. criteria using microphone signals: a loud sound (e.g., a sound with elevated volume levels, or energy levels greater than a predetermined number of standard deviations from a mean energy level), a close sound (e.g., sounds produced close to the microphone indicative of a user located near the microphone or speaking directly into the microphone), a change in frequency of sound (e.g., an increase in the frequency of verbal sounds), language of speech (e.g., a user speaking in Spanish or Chinese), non-language sounds (e.g., grunts, groans or other indications of frustration), impact sounds (e.g., the sound of a user hitting or kicking a component of user equipment 300 of FIG. 3A), query sounds (e.g., verbal phrases that end with an increase in pitch, which may indicate a question), recognized speech (e.g., phrases like “help” and “I'm lost” identified using speech processing techniques);
2. criteria using accelerometer signals (one, two or three-dimensional): accelerations above a threshold magnitude, accelerations with energy in particular frequency bands (e.g., about 1-5 Hz, which may indicate a user shaking a remote control), accelerations with high frequency components (may indicate a sudden impact), accelerations with a high amplitude frequency component (may indicate a user is tapping or bouncing a user equipment device);
3. criteria using force gauge signals: pressures above a threshold magnitude (may indicate that a user is squeezing or pressing on a user equipment device, or forcefully pressing buttons or a touch screen), pressures with a high amplitude frequency component (may indicate a user is tapping or repeatedly squeezing a user equipment device);
4. criteria using anemometer signals: wind speed above a threshold (may indicate that a user is rapidly moving or throwing a remote control or other user equipment device), wind speed that changes direction in a short interval of time (may indicate that a user is waving or shaking a user equipment device), intermittent wind pulses (may indicate that a user is speaking or yelling close enough to a user equipment device for the anemometer to detect the user's exhalations);
5. criteria using temperature sensor signals: temperature increasing (may indicate a user is tightly gripping or squeezing a handheld device), temperature decreasing or below a threshold (may indicate that a remote control has been lost or is inaccessible to a user);
6. criteria using level sensor signals: upside down (may indicate a user is incorrectly operating a user equipment device), level changing rapidly (may indicate a handheld device is rolling, or being tossed or thrown); and
7. criteria using user input interface signals: persistent signaling (e.g., repeated button pressing), incorrect signaling (e.g., invalid command signals), simultaneous signaling at multiple inputs (e.g., “button mashing”), random signaling (e.g., erratic cursor movement, random button pressing), voice tone in voice command system (e.g., slow, enunciated language may indicate user frustration), emphatic operation of input interface (e.g., hard button or touchpad presses, loud voice commands), repeated returns to a menu or home screen (may indicate a user's inability to locate a desired feature), invalid typed commands or typed commands indicative of frustration (e.g., “help!!”), responses to an emotion/preference query (e.g., a user responding “yes” when prompted by processing circuitry 306 of FIG. 3A to answer “Are you overwhelmed by the currently available options?”).

At step 704 (FIG. 7), processing circuitry 306 (FIG. 3A) may determine which portions of user signal data are relevant for evaluating the frustration pattern criteria accessed at step 702 (FIG. 7). For example, the criteria for frustration pattern x may use data from an accelerometer and a microphone included in user sensor 316 (FIG. 3A), and may not rely on other user signal data such as signals from user input interface 310 or other sensors included in user sensor 316. Each set of frustration pattern criteria may use data from one or more sources of user signal data, which may be wholly or partially different than the data used to evaluate other sets of frustration pattern criteria.

At step 706 (FIG. 7), processing circuitry 306 (FIG. 3A) may access the relevant user signal data for evaluating the criteria for frustration pattern x (as determined at step 704 of FIG. 7). In certain applications, evaluating which portions of user signal data are relevant for the specific frustration pattern criteria under consideration (i.e., frustration pattern x) may allow processing circuitry 306 to access only the relevant portions of user signal data, rather than the entire (possibly larger) user signal data set. This may be advantageous when communication bandwidth and/or processing power is at a premium. In an embodiment, step 704 need not be performed, or may be performed in conjunction with step 706. Processor circuitry may execute step 706 by accessing user signal data from any combination of local memory (e.g., storage 308) that may include RAM memory, FLASH memory, or a buffer, remote memory, or any other suitable memory architecture for storing user signal data.

At step 708 (FIG. 7), processing circuitry 306 (FIG. 3A) may process the user signal data accessed at step 706 (FIG. 7) to evaluate the criteria for frustration pattern x. The criteria may include one criterion or multiple criteria; in FIG. 7, the criterion under consideration is designated criterion y. In order to evaluate criterion y, processing circuitry 306 (FIG. 3A) may process one or more portions of the user signal data accessed at step 706 (FIG. 7). This processing may take the form of any one or more of filtering (e.g., one or more low-pass, high-pass, band-pass and notch filters), sampling (e.g., up-sampling or down-sampling), discretizing, analog-to-digital conversion, digital-to-analog conversion, mathematical operations (e.g., calculating a likelihood ratio for hypothesis testing), correlating (e.g., auto-correlating and/or cross-correlating), spectral transformations (e.g., Fourier or Z-transforming), power or energy assessments (e.g., root-mean-square values and/or energy in a particular frequency band), statistical operations (e.g., averaging, calculating means, modes, and standard deviations), and any other signal processing operation. It will be understood that any one or more of these signal processing operations may occur at any other stages in the frustration detection/mode adjustment processes of the present disclosure. For example, user signals may be filtered by hardware or software filters included in user input interface 310 (FIG. 3A) and/or user sensor 316, prior to being received by processing circuitry 306.

As depicted in FIG. 7, once criterion y is evaluated (step 708), processing circuitry 306 (FIG. 3A) may determine whether frustration pattern x has been identified in the user signal data (step 710 of FIG. 7). This determination may be based on the evaluation of criterion y, and may also be based on the evaluation of other criteria performed before, after, or in parallel with the evaluation of criterion y. In an embodiment, the determination made by processing circuitry 306 (FIG. 3A) at step 710 (FIG. 7) may have three possible outcomes. If processing circuitry 306 (FIG. 3A) determines that frustration pattern x is present in the user signal data, processing circuitry 306 may return a positive result for frustration pattern x at step 712 (FIG. 7). If processing circuitry 306 (FIG. 3A) determines that frustration pattern x is not present in the user signal data, processing circuitry 306 may return a negative result for frustration pattern x at step 714 (FIG. 7). Returning a positive or negative result may include setting a “frustration pattern detected” variable or flag, sending a message indicating the returned result to a user equipment device or a remote server via communications network 364 (FIG. 3B), recording the returned result in a memory, activating an indicator (such as an LED, on-screen display, buzzer or alarm) in user equipment 300 (FIG. 3A), using the result as an input in another part of a frustration detection/mode adjustment process (e.g., step 414 of FIG. 4), any other suitable response, or any combination thereof.

At step 710 (FIG. 7), processing circuitry 306 (FIG. 3A) may not determine whether frustration pattern x is present in user signal data. This may occur, for example, when additional criteria for frustration pattern x are to be evaluated, when the results of the evaluation of criterion y are ambiguous or inconclusive (e.g., the evaluation cannot be made with a desired statistical confidence), the user signal data used in the evaluation of criterion y is noisy, incomplete or corrupted, or additional user signal data is required. Flow chart 700 of FIG. 7 illustrates the process executed by processing circuitry 306 (FIG. 3A) when additional criteria are to be evaluated; from step 710 (FIG. 7), processing circuitry 306 processes user signal data for another criterion at step 708 of FIG. 7 (after incrementing the criterion variable y at step 716 of FIG. 7).

In the embodiment illustrated by flow chart 700 of FIG. 7, one criterion included in the criteria for frustration pattern x may be evaluated at a time, and the evaluation of the criteria proceeds sequentially from criterion to criterion. In an alternate embodiment, multiple criteria may be evaluated substantially simultaneously, and the full set of frustration pattern x criteria may be evaluated by any combination of sequential and parallel evaluations of single criteria. The order in which frustration pattern criteria are considered by processing circuitry 306 may be random or pre-determined. In an embodiment, the frustration pattern criteria may be considered in an order selected to minimize expected evaluation time. For example, if a particular criterion must be satisfied for the detection of an associated frustration pattern, and the particular criterion is not likely to occur by random, this criterion may be evaluated near the beginning of the frustration pattern detection process. If this criterion is not satisfied, processing circuitry 306 can return a negative result for the associated frustration pattern and no additional criteria need be considered (thereby reducing processing time). If this criterion is satisfied, the detection process may proceed to consider additional criteria (if necessary).

If all criteria for frustration pattern x have been evaluated and no determination of whether frustration pattern x is present in user signal data is made, processing circuitry 306 may default to providing a negative result at step 714 of FIG. 7 (and may record the inconclusive determination in a memory). At step 718, the frustration pattern variable x may be incremented, and processing circuitry 306 (FIG. 3A) may return to step 702 (FIG. 7) to access the criteria for another frustration pattern. As discussed above with reference to evaluating multiple criteria for frustration pattern x, determining whether one or more of multiple frustration patterns are present in user signal data may be performed sequentially, in parallel, or in any combination of sequential and parallel operations. For example, a first frustration pattern may be associated with a first criterion that is similar to (or the same as) a second criterion associated with a second frustration pattern. In an embodiment, processing circuitry 306 (FIG. 3A) may evaluate the first and second criterion substantially simultaneously (or as one set of operations), then use the result of the evaluation in a sequential determination of the presence of the first and second frustration patterns. Optimization and pipelining techniques may be used to improve the speed and efficiency with which processing circuitry 306 detects frustration patterns in user signal data.

FIG. 8 is a flow diagram 800 of an illustrative interaction mode adjustment process. Although the steps of flow chart 800 will be described as executed by processing circuitry 306 (FIG. 3A) for clarity of illustration, it will be understood that any mode adjustment process may be performed by any device or group of devices configured to do so; for example, special- or general-purpose processing circuitry located within user equipment device 300 or any appropriately-configured component of interactive media system 350 (FIG. 3B). In an embodiment, the steps of flow chart 800 (FIG. 8) may be executed by processing circuitry also configured to execute the steps of flow chart 400 (FIG. 4) or any other process described herein. In an embodiment, the steps of flow chart 800 (FIG. 8) may be performed in conjunction with the steps of flow chart 400 (FIG. 4), for example, at step 416 when processing circuitry 306 (FIG. 3A) adjusts the interaction mode.

At step 802 (FIG. 8), processing circuitry 306 (FIG. 3A) may determine the current interaction mode of the interactive application (e.g., an interactive media guide application). Processing circuitry 306 may perform step 802 (FIG. 8) as described above with reference to step 404 of flow diagram 400 (FIG. 4).

At step 804 (FIG. 8), processing circuitry 306 (FIG. 3A) may identify one or more frustration patterns that have been detected. The detection of frustration patterns may be performed in accordance with the steps of flow diagram 700 (FIG. 7, discussed above) or any known pattern recognition technique. For example, the identification of a detected frustration pattern at step 804 (FIG. 8) may be based on the result returned at step 712 or 714 of flow diagram 700 (FIG. 7). Identifying a frustration pattern may include querying one or more “frustration pattern detected” variables, receiving one or more “frustration pattern detected” flags, receiving a message indicating which frustration patterns have been detected, retrieving a frustration pattern detection result from a memory, receiving an indication of a detected frustration pattern as an output from another part of a frustration detection/mode adjustment process (e.g., step 712 or 714 of FIG. 7), any other suitable method of identification, or any combination thereof.

At step 806 (FIG. 8), after identifying one or more detected frustration patterns, processing circuitry 306 (FIG. 3A) determines a target interaction mode to be implemented by the interactive application to respond to the user's frustration. Factors that may be used to determine the target interaction mode include demographic information about the user, history of use of the interactive application (including use of different interaction modes), history of frustration patterns, the current interaction mode, preferences set by the user (e.g., for display settings), the experiences of a group of users with different interaction modes (e.g., as compiled in a central database), or any other factors indicative of the source of a user's frustration and/or an interaction mode adjustment that may reduce the user's frustration. In an embodiment, processing circuitry 306 executes a decision-tree algorithm to determine the target interaction mode to be implemented, based on one or more of the above factors or any other factor described herein. In an embodiment, processing circuitry 306 consults a look-up table stored in memory (e.g., storage 308 or a remote database) that indicates a target interaction mode to be implemented based on the current interaction mode and the frustration pattern(s) detected (and/or based on any other factor described herein). For example, a microphone, located in a set-top box, may receive noises of increasing volume when a television displays a screen similar to display 100 of FIG. 1. Processing circuitry 306 (FIG. 3A) may detect, using this microphone signal and any additional signal, a frustration pattern indicative of a user speaking as he or she approaches the set-top box. Using this detected frustration pattern (which may indicate the user's inability to clearly view the displayed listings from a distance), the current interaction mode (represented by screen 100 of FIG. 1), as well as any additional information (e.g., information about this user's history of frustration patterns), processing circuitry 306 (FIG. 3A) may determine that the television should display screen 500C of FIG. 5C, representing a target interaction mode with a larger text size for easier visibility.

At step 808 (FIG. 8), processing circuitry 306 (FIG. 3A) receives parameters associated with the target interaction mode determined at step 806 (FIG. 8). These parameters specify the presentation of a set of interactive application elements and include available options, valid user commands, display characteristics and items presented to the user. Examples of available options include any one or more of navigation options (e.g., as used in media guide applications, computer software, and handheld devices), accessing additional information associated with one or more of the presented items, selecting one or more presented items, scheduling a recording, making a purchase, downloading data, editing one or more files, viewing one or more files (e.g., a video file, a PDF file), creating one or more files, exiting an application, searching or exploring a database (e.g., a program listings database in an EPG), communicating information (e.g., via a Twitter feed), interacting with a feature (e.g., playing a game, solving a problem), or any other option available to a user in the interactive application. Valid user commands include any user input signal (e.g., transmitted to processing circuitry 306 of FIG. 3A via user input interface 310) that is recognized by processing circuitry 306 as responsive to an available option. Examples of display characteristics include any one or more of display requirements (e.g., minimum or maximum font size), display templates (e.g., as specified by a stylesheet or described by a set of instructions in a mark-up language such as HTML or LaTeX), and display preferences (e.g., as selected by a user). Examples of items presented to the user include any one or more of information from an EPG database (e.g., television or VOD program listings), graphic and video segments (e.g., news clips, music videos, animations), information from an advertisement database (e.g., commercials, advertising banners, sponsor logos), information from a real-time data feed (e.g., sports scores, weather, stock tickers), information from the VBI of a television signal (e.g., closed-caption information), information from an audio stream (e.g., a digital or analog radio station), information from an Internet source (e.g., shopping websites, encyclopedia websites, social networking websites, Twitter feeds), information from media content source 366 of FIG. 3B, interactive features (e.g., games, mathematics puzzles, photo editing, instant messaging), information from other users (e.g., status updates, recommendations, photographs, electronic gifts), or any other item that may be presented to a user by an interactive application.

In an embodiment, processing circuitry 306 (FIG. 3A) assembles the interactive application elements, which may be stored at or provided by any one or more component in interactive system 350 of FIG. 3B, in accordance with the parameters associated with the target interaction mode. In an alternate embodiment, the interactive application elements are assembled, in accordance with the parameters associated with the target interaction mode, by a device other than processing circuitry 306 (e.g., media guidance data source 368 of FIG. 3B) and then provided to processing circuitry 306 (e.g., via communications network 364 of FIG. 3B).

At step 810 (FIG. 8), processing circuitry 306 (FIG. 3A) presents the interactive application elements to the user according to the target interaction mode parameters received at step 808. In order to use the target interaction mode parameters to present interaction application elements, software or hardware for interpreting, compiling, translating and/or rendering may be used. For example, target interaction mode parameters may be provided as one or more HTML, Javascript or CSS files that can be interpreted by an HTML reader or web browser executed by a processing device and rendered on a display, such as a monitor, through a monitor controller (e.g., a video or graphics card in a computer system). The target interaction mode parameters may specify which one or more of multiple user equipment devices are to be used when presenting the interactive application elements (e.g., a PDA included in wireless user communications device 356, or a television included in user television equipment 352 of FIG. 3B). In an embodiment, the target interaction mode parameters may specify different interactive application elements for presenting the interactive application on different user equipment devices with different capabilities. For example, a user struggling to use a PDA to view program listings may be presented with a larger display of the program listings on a nearby television screen when a frustration pattern is detected. Presenting the interactive application elements to the user may include presenting elements on a visual display, an audio display, a tactile display, a printed display or any other medium which can be understood by a user. In an embodiment, a user may have the option to override an interaction mode adjustment. For example, processing circuitry 306 (FIG. 3A) may detect a frustration pattern and adjust the interaction mode according to any of the techniques described herein. If the user does not wish to have the interaction mode adjusted, the user may input an override command to processing circuitry via user input interface 310. In another embodiment, if one or more additional frustration patterns are detected after an interaction mode adjustment (e.g., which may indicate that a user's frustration has increased since the interaction mode adjustment), processing circuitry 306 may revert back to the original interaction mode. This adjustment and subsequent override may be recorded in an interaction mode adjustment history (described below with reference to step 812 of FIG. 8).

At step 812 (FIG. 8), processing circuitry 306 (FIG. 3A) updates a stored interaction mode adjustment history with information regarding steps 802-810 (FIG. 8). This information may include any combination of the current interaction mode determined at step 802, the frustration pattern identified at step 804, the target interaction mode determined at step 806, the target interaction mode parameters received at step 808, a user response to step 810 (e.g., a valid command received via user input interface 310 (FIG. 3A), user signals indicative of user satisfaction or frustration), statistics of the circumstances of the execution of steps 802-810 (e.g., time, date, identity of user, type of user equipment) and any other information. In an embodiment, this information may be stored in a local memory (e.g., storage 308 of FIG. 3A). In an embodiment, the information may be stored in a remote database (e.g., connected to processing circuitry 306 of FIG. 3A via communications network 364 of FIG. 3B) along with similar information from other users. In an embodiment, this information may be used to improve the determination of a target interaction mode based on detected frustration patterns, and/or the detection of frustration patterns themselves. For example, processing circuitry 306 (or a remote processor located at media guidance data source 368 of FIG. 3B) may execute machine learning techniques to learn which user signals are most informative of user frustration. These learning techniques may be used to improve the performance of the frustration detection/mode adjustment systems described herein for individual users, and/or may be applied to data collected from multiple users to improve performance for a population of users.

In certain embodiments, after an interaction mode has been adjusted in response to a detected frustration pattern, processing circuitry 306 (FIG. 3A) may return to the previous interaction mode, or may transition to an entirely different interaction mode. This may occur after a pre-determined time period (e.g., 30 seconds, as specified in control circuitry 304 by default or by a user), a variable time period (e.g., a time period that is different for different frustration patterns detected and/or different target interaction modes), when user frustration patterns are no longer detected, when user satisfaction patterns are detected (which may be defined according to any of the criteria described herein and may represent a user appropriately using the interactive application and/or providing positive feedback to processing circuitry 306), after a certain number of features have been used (e.g., a certain number of different screens have been displayed), or at the next start-up of the interactive application or next user log-in. Such embodiments may be advantageous when a user's frustration with the interactive application is limited in duration, and the previous interaction mode (which may include more features than the target interaction mode) may be resumed without causing excessive user frustration. In such embodiments, a user may be gradually exposed to the features available in a nominal interaction mode, and can be provided with a target interaction mode when his or her frustration becomes too great. Such embodiments may encourage a user to continue to develop his or her proficiency with the interactive application.

The systems and processes described herein may be constantly updated and refined with additional frustration patterns and interaction modes. These updates may be provided to user equipment 300 (FIG. 3A) from a remote source via communications network 364 (FIG. 3B), manually provided to user equipment 300 through a portable storage medium such as a compact disc, DVD or USB memory stick, or learned locally by user equipment 300 (FIG. 3A) as described above. These updates may also be stored and used remotely (e.g., in embodiments in which frustration detection and/or mode adjustment is performed remotely from user equipment 300). In an embodiment, one or more users may submit recommendations for interaction modes or provide feedback on interaction modes to a remote server (such as media guidance data source 368 of FIG. 3B). Recommendations and feedback may be submitted by user equipment 300 (FIG. 3A) automatically, or may be submitted by a user to a remote server or human operator via any communications protocol (e.g., an e-mail, a telephone call). In an embodiment, a user may select one or more interaction modes for use with their user equipment 300, either as a target interaction mode to be implemented in response to certain frustration patterns, or as a default interaction mode for an interactive application. In an embodiment, a user's habits (e.g., common frustration patterns and preferred interaction modes) may be monitored and compared to the habits of other users in order to customize the user's interactive application with interaction modes that users with similar habits found satisfying.

The frustration detection/mode adjustment systems and methods disclosed herein may be modified to identify and/or respond to the particular user or users interacting with the interactive application (e.g., by interacting with any of the user equipment devices). Just as the frustration detection/mode adjustment systems and methods described herein may evaluate different sets of criteria to detect frustration patterns in user signal and provide a target interaction mode in response, the systems and methods described herein may be applied to evaluate different sets of criteria to detect/distinguish different users based on identification patterns in user signals and provide a customized interaction mode in response. Any one or more user signals may be monitored for identification patterns. In certain embodiments, signals from user input interface 310 (FIG. 3A) may be monitored to identify which channels or programs are first or most commonly tuned to by a particular user, which application features are most commonly used by a particular user, which kinds of search queries are most commonly run by a particular user, what time of day a particular user most commonly uses an interactive application feature etc., and use any one or more user input interface signal to distinguish different users. In certain embodiments, signals from user sensor 316 (FIG. 3A) may be monitored to identify how gently or firmly a remote control or handheld device is gripped by a particular user, the tone and frequency characteristics of a particular user's voice, motions commonly used when a particular user interacts with user equipment devices (e.g., swinging a remote control, jogging with a mobile music device), and use any one or more user sensor signal to distinguish different users. These identification patterns may be developed by correlating with user identify information provided by a log-in or password feature, and/or may be learned by processing circuitry 306 or any other suitable processing device included in system 350 (FIG. 3B) executing a machine-learning technique.

Additionally, the detection of a particular user identification pattern may trigger an interaction mode adjustment, as is described herein for triggering interaction mode adjustments in response to the detection of different frustration patterns. In certain embodiments, processing circuitry 306 (FIG. 3A) may detect a particular user by evaluating a set of user identification criteria, then adjust the interaction mode to a target mode that the particular user may prefer. The user's preference may be based on user-input customizations or settings, or may be learned by the system 350 (FIG. 3B) by monitoring user signals and activity within the interactive application, as described elsewhere herein. For example, a user with poor hearing may tend to turn up the volume immediately after turning on the television and may repeatedly enter invalid commands on a remote control even after an error “beep” is sounded. Processing circuitry 306 (FIG. 3A) or another processing device may use any one or more patterns in these user input interface signals and user sensor signals to identify this particular user (e.g., as a “type” of user with poor hearing, or as a “unique” user, for example, a particular member of a particular family). Processing circuitry 306 or another processing device may then adjust the interaction mode to a target interaction mode that may be preferable to the user (e.g., turning on closed-captioning during television programming).

Adjustment of an interaction mode in response to user identification (or adjustment of an interaction mode in response to any condition described herein, including detection of a frustration pattern) may be performed at suitable moments in the user's use of the interactive application. In certain embodiments, an interaction mode adjustment is delayed until a user reaches a suitable point in the use of the interactive application. For example, when a user is scrolling through a menu when a frustration pattern is detected, an interaction mode adjustment may be delayed until the user has paused in scrolling or has selected another application feature. In certain applications, delaying interaction mode adjustments until moments of pause or feature change may be less jarring to a user and thereby reduce frustration. In other embodiments, an interaction mode adjustment is performed immediately upon detection of a frustration pattern or other condition, or delayed by a pre-determined period after detection of a frustration pattern or other condition.

The frustration detection/mode adjustment systems and methods disclosed herein may be modified to detect and/or respond to reactions other than user frustration including satisfaction, excitement, enthusiasm, apathy, indecision, boredom, impatience, stress, or any other user state. In embodiments which detect and/or respond to any of these user states, the user signals described herein may be analyzed for the presence of patterns indicative of the user state, and interaction modes adjusted accordingly. Any known technique for determining information about a user from user signals may be used with the systems and methods for interaction mode adjustment disclosed herein.

The following discussion addresses further embodiments of display screens, user equipment and systems suitable for use with the frustration detection/mode adjustment techniques described herein. As noted above, the following discussion will often be presented in the context of media delivery applications, but it will be understood that these illustrative examples do not limit the range of interactive applications which may be improved by the use of the frustration detection/mode adjustment techniques of the present disclosure.

With the advent of the Internet, mobile computing, and high-speed wireless networks, users are engaging with interactive applications and accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices as well. The guidance provided may be for media content available only through a television, for media content available only through one or more of these devices, or for media content available both through a television and one or more of these devices. Media guidance applications may be provided as on-line applications (i.e., provided on a website), or as stand-alone applications or clients on hand-held computers, PDAs, mobile telephones, or other mobile devices. The various devices and platforms that may implement media guidance applications are described in more detail elsewhere herein.

In addition to providing access to linear programming provided according to a schedule, media guidance applications may provide access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), remotely-stored media content (e.g., video content stored on a remote device such as a web server, a remote hard drive, or a networked hard drive), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or webcast, or content available on-demand as streaming media or downloadable media through an Internet web site or other Internet access (e.g., FTP).

In FIG. 1, grid 102 of display 100 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, stored media assets, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements (e.g., visual or audible advertisements) may be included in any other interactive application display of the present disclosure (e.g., in place of any other interactive application element disclosed herein).

In an embodiment, display 200 of FIG. 2 may be augmented by any of the items and features described above for display 100 of FIG. 1. For example, advertisement 205 may take the form of any of the embodiments described above for advertisement 124. The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

As discussed above, the systems and methods of the present disclosure may be implemented in whole or in part by user equipment 300 of FIG. 3A, which includes control circuitry 304. Control circuitry 304 may be based on any suitable processing circuitry 306 such as processing circuitry based on one or more microprocessors, microcontrollers, digital signal processors, programmable logic devices, etc. In an embodiment, control circuitry 304 executes instructions for an interactive application stored in memory (i.e., storage 308). In client-server based embodiments, control circuitry 304 may include communications circuitry suitable for communicating with an interactive application server or other networks or servers. Such servers may provide, for example, remote storage of frustration pattern criteria and interaction mode adjustment histories. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (described in more detail in connection with FIG. 3B). In addition, communications circuitry may include circuitry that enables peer-to-peer communication of user equipment devices, or communication of user equipment devices in locations remote from each other. Server-centric and/or peer-to-peer communication may enable the pooling of interaction mode adjustment histories between users, as well as any information related to the frustration detection/mode adjustment techniques disclosed herein.

Memory (e.g., random-access memory, read-only memory, or any other suitable memory), hard drives, optical drives, or any other suitable fixed or removable storage devices (e.g., DVD recorder, CD recorder, video cassette recorder, USB devices, or other suitable recording devices) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application or any other interactive application. Nonvolatile memory may be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may be provided. Control circuitry 304 may include scaler circuitry for upconverting and downconverting media into the preferred output format of the user equipment 300. Circuitry 304 may include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A guidance application (or any interactive application) may be implemented using any suitable architecture. For example, an interactive application may be a stand-alone application wholly implemented on user equipment device 300. In such an approach, instructions of the application are stored locally, and data for use by the application is downloaded on a periodic basis (e.g., from the VBI of a television channel, from an out-of-band feed, or using another suitable approach). In another embodiment, a media guidance application is a client-server based application. Data for use by a thick or thin client implemented on user equipment device 300 is retrieved on-demand by issuing requests to a server remote to the user equipment device 300. In one example of a client-server based application, control circuitry 304 runs a web browser that interprets web pages provided by a remote server.

In other embodiments, a media guidance application is downloaded and interpreted or otherwise run by an interpreter or virtual machine (run by control circuitry 304). In an embodiment, a guidance application may be encoded in the ETV Binary Interchange Format (EBIF), received by control circuitry 304 as part of a suitable feed, and interpreted by a user agent running on control circuitry 304. For example, a guidance application may be a EBIF widget. In other embodiments, an application may be defined by a series of JAVA-based files that are received and run by a local virtual machine or other suitable middleware executed by control circuitry 304. In some of such embodiments (e.g., those employing MPEG-2 or other digital media encoding schemes), a guidance application may be, for example, encoded and transmitted in an MPEG-2 object carousel with the MPEG audio and video packets of a program.

User television equipment 352 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated into a single device, if desired. User computer equipment 354 may include a PC, a laptop, a tablet, a WebTV box, a personal computer television (PC/TV), a PC media server, a PC media center, or other user computer equipment. WEBTV is a trademark owned by Microsoft Corp. Wireless user communications device 356 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 352, user computer equipment 354, and wireless user communications device 356 may utilize at least some of the system features described above in connection with FIG. 3A and, as a result, include flexibility with respect to the type of media content available on the device. For example, user television equipment 352 may be Internet-enabled allowing for access to Internet content, while user computer equipment 354 may include a tuner allowing for access to television programming. A media guidance application may also have the same layout on the various different types of user equipment or may be tailored to the display capabilities of the user equipment. For example, on user computer equipment, a guidance application may be provided as a web site accessed by a web browser. In another example, an interactive application may be scaled down for wireless user communications devices.

In system 350, there is typically more than one of each type of user equipment device but only one of each is shown in FIG. 3B to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may set various settings to maintain consistent media guidance application settings across in-home devices and remote devices. Settings include those described herein, as well as channel and program favorites, programming preferences that a guidance application utilizes to make programming recommendations, interaction mode preferences and settings, frustration detection preferences and settings, display preferences, and other desirable settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

Although communications paths are not drawn between user equipment devices, these devices may communicate directly with each other via communication paths, such as those described above in connection with paths 358, 360, and 362, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may communicate with each other directly or through an indirect path via communications network 364.

Media content source 366 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 366 may be the originator of media content (e.g., a television broadcaster, a webcast provider, etc.) or may not be the originator of media content (e.g., an on-demand media content provider, an Internet provider of video content of broadcast programs for downloading, Twitter feeds, etc.). Media content source 366 may include cable sources, satellite providers, on-demand providers, Internet providers, peer content providers or other providers of media content. Media content source 366 may include a remote media server used to store different types of media content (including video content selected by a user), in a location remote from any of the user equipment devices. Systems and methods for remote storage of media content, and providing remotely stored media content to user equipment are discussed in greater detail in connection with Ellis et al. U.S. patent application Ser. No. 09/332,244, filed Jun. 11, 1999, which is hereby incorporated by reference herein in its entirety.

Media guidance data source 368 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance data may include data useful for frustration pattern detection and/or interaction mode adjustment applications run on user equipment. Such data may, for example, provide frustration pattern criteria and interaction mode parameters. Moreover, a data source like media guidance data source 368 may support any interactive application (e.g., an online community, a multi-player online game, a stock trading forum, etc.).

Interactive application data may be provided to user equipment devices using any suitable approach. In an embodiment, a guidance application may be a stand-alone interactive television program guide that receives program guide data via a data feed (e.g., a continuous feed, trickle feed, or data in the vertical blanking interval of a channel). Program schedule data and other guidance data may be provided to user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to user equipment with any suitable frequency (e.g., continuously, daily, a user-specified period of time, a system-specified period of time, in response to a request from user equipment, etc.). In some approaches, guidance data from media guidance data source 368 may be provided to users' equipment using a client-server approach. For example, a guidance application client residing on the user's equipment may initiate sessions with source 368 to obtain guidance data when needed. Media guidance data source 368 may provide user equipment devices 352, 354, and 356 the media guidance application itself or software updates for the media guidance application.

Interactive applications may be, for example, stand-alone applications implemented on user equipment devices. In other embodiments, interactive applications may be client-server applications where only the client resides on the user equipment device. For example, media guidance applications may be implemented partially as a client application on control circuitry 304 of user equipment device 300 and partially on a remote server as a server application (e.g., media guidance data source 368). The guidance application displays may be generated by the media guidance data source 368 and transmitted to the user equipment devices. The media guidance data source 368 may transmit data for storage on the user equipment, which then generates the guidance application displays based on instructions processed by control circuitry 304.

Media guidance data source 368 may make frustration pattern detection and/or interaction mode adjustment applications available to users. Such applications may be downloaded from media guidance data source 368 to a user equipment device, or may be accessed remotely by a user. These applications, as well as other applications, features and tools, may be provided to users on a subscription basis or may be selectively downloaded or used for an additional fee. In an embodiment, media guidance data source 368 may serve as a repository for frustration pattern criteria and interaction mode parameters developed by users and/or third-parties, and as a distribution source for this data and related applications. Media guidance system 350 is intended to illustrate a number of approaches, or network configurations, by which user equipment devices and sources of media content, interactive applications and guidance data may communicate with each other for the purpose of accessing media and providing interactive applications and media guidance. The present disclosure may be applied in any one or a subset of these approaches, or in a system employing other approaches for delivering media and providing interactive applications and media guidance. The following three approaches provide specific illustrations of the generalized example of FIG. 3B.

In one approach, user equipment devices may communicate with each other within a home network. User equipment devices can communicate with each other directly via short-range point-to-point communication schemes describe above, via indirect paths through a hub or other similar device provided on a home network, or via communications network 364. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 366 to access media content. Specifically, within a home, users of user television equipment 354 and user computer equipment 356 may access the media guidance application to navigate among and locate desirable media content. Users may also access the media guidance application outside of the home using wireless user communications devices 356 to navigate among and locate desirable media content.

It will be appreciated that while the discussion of media content has focused on video content, the principles of media guidance can be applied to other types of media content, such as music, images, text, etc.

It is to be understood that while the invention has been described in conjunction with the various illustrative embodiments, the forgoing description is intended to illustrate and not limit the scope of the invention. While several embodiments have been provided in the present disclosure, it should be understood that the disclosed systems, components, and methods may be embodied in many other specific forms without departing from the scope of the present disclosure.

The intention is not to be limited to the details given herein or implemented in sub-combinations with one or more other features described herein. For example, a variety of systems and methods may be implemented based on the disclosure and still fall within the scope of the invention. Also, the various features described or illustrated above may be combined or integrated in other systems or certain features may be omitted, or not implemented.

Examples of changes, substitutions, and alterations are ascertainable by one skilled in the art and could be made without departing from the scope of the information disclosed herein. Certain particular aspects, advantages, and modifications are within the scope of the following claims. All references cited herein are incorporated by reference in their entirety and made part of this application.

What is claimed is:

1. A method for providing a media guide, comprising:
providing a display, including first and second items, according to a first interaction mode;
receiving a signal from at least one user sensor, wherein the received signal is not a valid command signal;
detecting a frustration pattern based on the received signal; and
in response to detecting the frustration pattern,
providing a display, including at least the first item, according to a second interaction mode.

2. The method of claim 1, wherein the first and second items are user-selectable options.

3. The method of claim 1, wherein the first and second items are media information items.

4. The method of claim 1, wherein providing the display according to the second interaction mode comprises providing a display including the first item and not including the second item.

5. The method of claim 4, wherein the first and second items are presented substantially simultaneously in the display provided according to the first interaction mode

6. The method of claim 1, wherein providing the display according to the second interaction mode comprises masking the second item in the display.

7. The method of claim 1, wherein providing the display according to the second interaction mode comprises increasing the size of the first item in the display.

8. The method of claim 7, wherein providing the display according to the second interaction mode further comprises decreasing the size of the second information item in the display.

9. The method of claim 1, wherein receiving a signal from at least one user sensor occurs after providing the display according to the first interaction mode, the method further comprising:
after providing the display according to the second interaction mode, providing the display according to the second interaction mode.

10. The method of claim 9, wherein providing the display according to the first interaction mode, after providing the display according to the second interaction mode, occurs a pre-determined time period after providing the display according to the second interaction mode.

11. A system for providing a media guide, comprising:
a display device;
at least one user sensor;
a processor, configured to communicate with the display device and the user sensor, and further configured to:
provide a display, including first and second items, with the display device, according to a first interaction mode;
receive a signal from the at least one user sensor, wherein the received signal is not a valid command signal;
detect a frustration pattern based on the received signal; and
in response to detecting the frustration pattern,
provide a display, including at least the first item, with the display device, according to a second interaction mode.

12. The system of claim 11, wherein the first and second items are user-selectable options.

13. The system of claim 11, wherein the first and second items are media information items.

14. The system of claim 11, wherein providing the display according to the second interaction mode comprises providing a display including the first item and not including the second item.

15. The system of claim 14, wherein the first and second items are presented substantially simultaneously in the display provided according to the first interaction mode.

16. The system of claim 11, wherein providing the display according to the second interaction mode comprises masking the second item in the display.

17. The system of claim 11, wherein providing the display according to the second interaction mode comprises increasing the size of the first item in the display.

18. The system of claim 17, wherein providing the display according to the second interaction mode further comprises decreasing the size of the second information item in the display.

19. The system of claim 11, wherein the processor receives the signal from the at least one user sensor after providing the display according to the first interaction mode, and the processor is further configured to:
after providing the display according to the second interaction mode, provide the display, with the display device, according to the first interaction mode.

20. The system of claim 19, wherein providing the display according to the first interaction mode, after providing the display according to the second interaction mode, occurs a pre-determined time period after providing the display according to the second interaction mode.
